(19) United States
(12) Patent Application Publication
(10) Pub. No.: US 2008/0100553 A1
(43) Pub. Date: May 1, 2008

(54) Driving System and Multi-Gamma Driving Method for LCD Panel

(75) Inventors: Yuh-Ren Shen, Tainan City (TW); Chang-Cheng Lin, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: VASTVIEW TECHNOLOGY, INC., Hsinchu (TW)

(21) Appl. No.: 11/611,109

(22) Filed: Dec. 14, 2006

(30) Foreign Application Priority Data
Oct. 26, 2006 (TW) 095139602

(51) Int. Cl. G09G 3/36

(52) U.S. Cl. 345/89

(57) ABSTRACT

The present invention relates to a liquid crystal display device and a method of driving the same. The steps of the method contains: (1) upgrade the frame rate up to p/q times (p, q are natural numbers and p>q) and produce a series of output frames; (2) conduct grey level conversions for the series of output frames using different mapping curves based on different gamma values; (3) process the series of converted output frames by an appropriate gamma correction curve and presents the output frames on the LCD panel by an appropriate scanning method. In step (2) of the present invention, two grey level mapping curves, each specified by a specific gamma value, are applied alternately to the series of output frames and the two grey level mapping curves can be identical or different. Thus, the enhancement in brightness and high display performance and quality can be achieved.

### BACKGROUND OF THE INVENTION

1. Field of the Invention

The present invention generally relates to a liquid crystal display device and a method of driving the same, and more particularly to a method utilizing frame rate upgrade to provide multi-gamma driving to a liquid crystal display panel in order to provide a high quality image and display performance.

2. The Prior Arts

For a liquid crystal display (LCD), the transmittance of the liquid crystal molecule is a function of the voltage applied to the liquid crystal molecule. For example, the transmittance (T) versus the applied voltage (V) characteristic curve (or the so-called V-T curve) of a VA (vertical alignment) typed LCD liquid crystal molecule is shown in FIG. 1 while the V-T curve for a TN (twist nemanic) typed LCD liquid crystal molecule is shown in FIG. 1b, where V_{TH} in the diagrams is the threshold operation voltage of the liquid crystal molecule. As illustrated, such a function is not a linear one which means, for example, doubling the applied voltage will not double or half the transmittance.

Therefore, conventional driving methods to an ordinary LCD panel utilizes such a non-linear relationship between the transmittance and the applied voltage to fit the human eye's visual characteristics in distinguishing brightness variation. FIG. 1c is a schematic diagram showing the driving system of a conventional LCD panel. As shown, the conventional driving system 10 contains a timing control circuit 11, a source driving circuit module 12, a gate driving circuit module 13. The timing control circuit 11 in turn contains a timing controller 111 and a gamma correction circuit 112. The source driving circuit module 12 contains multiple source drivers 121 while the gate driving circuit module 13 contains multiple gate drivers 131. The source drivers 121 and the gate drivers 131 are usually positioned along the top edge and along a side of the LCD panel 14 and drive the data lines and gate lines of the LCD panel 14, respectively, to provide image data. During the process that the grey levels of the panel's pixels are delivered to the timing control circuit 11, they are converted to appropriate voltages by the conventional gamma correction circuit 112 in accordance with a so-called gamma correction curve, and then applied to the liquid crystal molecules of the LCD panel 14 to achieve the desired transmittances via the source driving circuit module 12. For the conventional VA-typed LCD panel, the gamma correction curve is shown in FIG 1d, while, for the conventional TN-typed LCD panel, the gamma correction curve is shown in FIG 1e, where V_{com} in the diagrams is the reference voltage of the liquid crystal molecule. Taking FIG 1d as example, to cause the liquid crystal molecule to produce positive-polarity or negative-polarity twist, the gamma correction circuit 112 conducts the conversion in accordance with the gamma correction curve above or below V_{com}. After such a conversion, regardless whether it is a VA- or TN-typed LCD panel, the relationship between the transmittance and the grey level of the liquid crystal molecule is shown in FIG 1f.

Please note that, despite of its effectiveness, the curve shown in FIG 1f does not necessarily provide the conversion most ideally to human eyes under all circumstance. For example, one of the major drawbacks of the conventional single-gamma driving method is that it is not adaptable to cover the characteristics of the displayed images (such as whether they are dynamic or static images). The conventional driving method therefore cannot deliver a performance where both the brightness and image quality are enhanced.

### SUMMARY OF THE INVENTION

To obviate the foregoing shortcomings of the conventional gamma correction, the present invention provides a driving system and a method that utilize frame rate conversion to conduct multiple-gamma driving, so as to achieve enhancements both in terms of dynamic image quality and the presentation of chromaticity and increased color levels.

The present invention provides a novel driving method for the LCD panel. The steps of the method contains: (1) upgrade the frame rate up to p/q times (p, q are natural numbers and p>q) and produce a series of output frames; (2) conduct grey level conversions for the series of output frames using different mapping curves based on different gamma values; (3) process the series of converted output frames by an appropriate gamma correction curve and presents the output frames on the LCD panel by an appropriate scanning method.

In step (2) of the present invention, two grey level mapping curves, each specified by a specific gamma value, are applied alternately to the series of output frames and the two grey level mapping curves can be identical or different.

In an alternative embodiment of the present invention, a decision about whether the output frames containing dynamic images is conducted before step (2). If yes, the foregoing process is continued; otherwise, the two grey level mapping curves are substantially identical.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is the V-T curve for the liquid crystal molecules of a VA-typed LCD panel.

FIG. 1b is the V-T curve for the liquid crystal molecules of a TN-typed LCD panel.

FIG. 1c is a schematic diagram showing the driving system of a conventional LCD panel.

FIG. 1d is the gamma correction curve for a conventional VA-typed LCD panel.

FIG. 1e is the gamma correction curve for a conventional TN-typed LCD panel.

FIG. 1f is the relationship between the transmittance and the grey level of the liquid crystal molecule of a conventional LCD panel.

FIG. 2a is a schematic diagram showing the timing control circuit of a LCD panel embodying the present invention.

FIG. 2b is a timing diagram showing the input and output frames of an embodiment of the present invention where the frame rate is upgraded to two times.

FIG. 2c is a timing diagram showing the input and output frames of an embodiment of the present invention where the frame rate is upgraded to 1.5 times.

FIG. 3a is a schematic diagram showing the process of the multi-gamma driving method according to an embodiment of the present invention.

FIG. 3b is a schematic diagram showing the process of the multi-gamma driving method according to another embodiment of the present invention.

FIG. 4a is a schematic diagram showing a timing control circuit according to an embodiment of the present invention which distinguishes static and dynamic images.

FIG. 4b is a schematic diagram showing the process of the multi-gamma driving method of FIG. 4a.

FIG. 5a is a schematic diagram showing the alternate applications of the grey level mapping curves in a temporal manner according to an embodiment of the present invention.

FIG. 5b is a schematic diagram showing the alternate applications of the grey level mapping curves in a temporal manner according to another embodiment of the present invention.

FIG. 5c shows a number of approaches to the alternate applications of the grey level mapping curves in various spatial manners.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

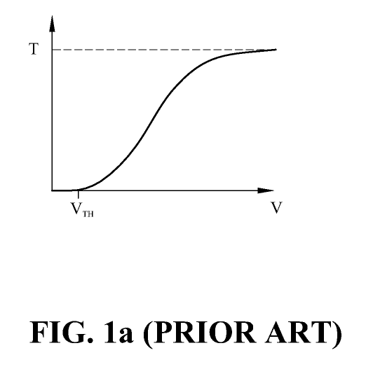

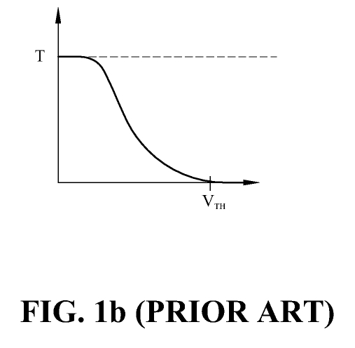

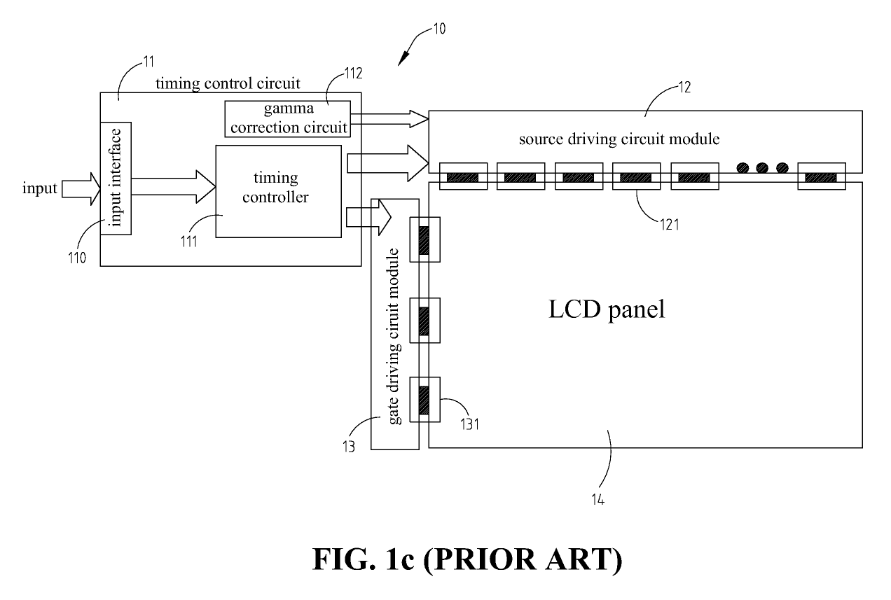

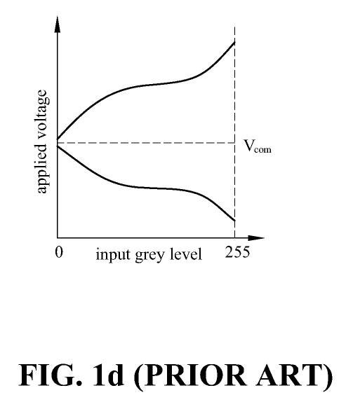

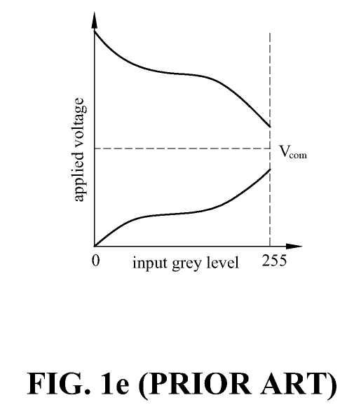

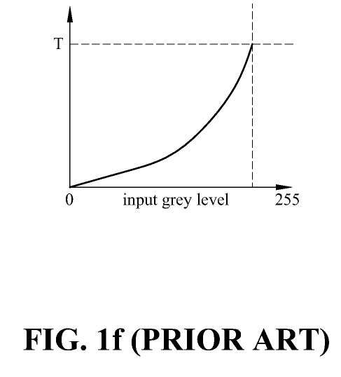

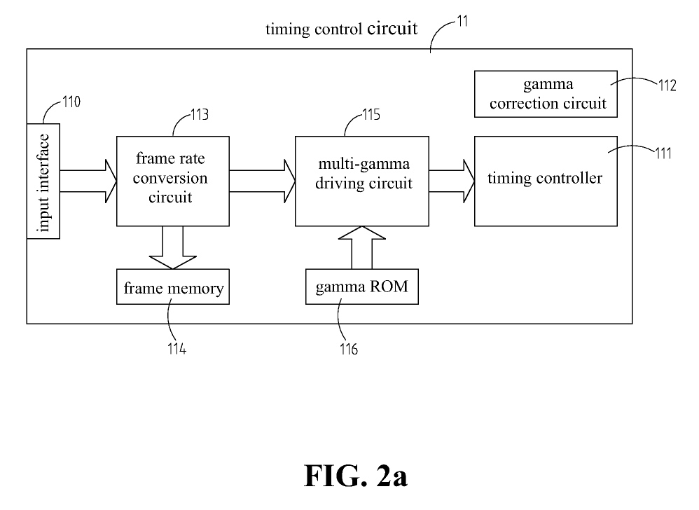

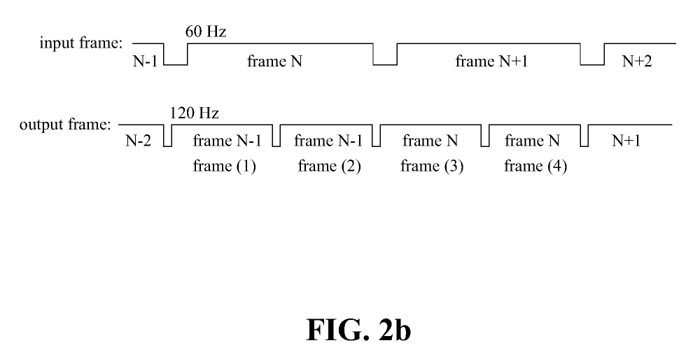

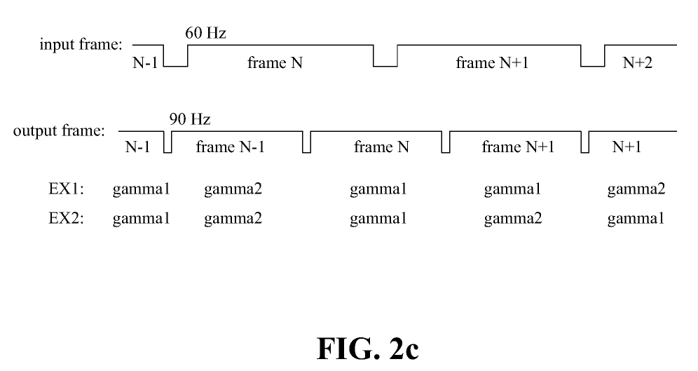

The present invention provides a multi-gamma driving method to a LCD panel through frame rate conversion. FIG. 2a is a schematic diagram showing the timing control circuit of a LCD panel embodying the present invention. In contrast to the timing control circuit 11 of the convention LCD panel of FIG 1c, the timing control circuit of the present invention provides a frame rate conversion module and a multi-gamma driving circuit module in series between the input interface 110 and the timing controller 111. The frame rate conversion circuit module contains a frame rate conversion circuit 113 and a frame memory 114. On the other hand, the multi-gamma driving circuit module contains a multi-gamma driving circuit 115 and a gamma ROM 116.

Through the function of the frame rate conversion circuit module, the present invention upgrades the frame rate (usually 60 Hz) of the input frames to the timing control circuit 11 up to p/q times (p, q are both natural numbers and p>q). FIGS. 2b and 2c are two possible scenarios of the output frames from the frame rate conversion circuit 113. As shown in FIG. 2b, the frame rate of the output frames is accelerated to 120 Hz (i.e., p=2, q=1) while, in FIG. 2c, the frame rate is promoted to 90 Hz (i.e., p=3, q=2). Please note that the method of frame rate upgrade or conversion is the not the subject matter of the present invention and many related techniques are already disclosed. One of the most common technique is to double the frame rate (i.e., up to 120 Hz) and, then, to apply overdriving voltage to enhance the response speed of the LCD panel. As such, the details about how the frame rate is upgraded are omitted in the present specification and the present invention does not require the adoption of specific acceleration method or frame rates.

As shown in FIGS. 2b and 2c, due to the increased frame rate, the number of output frames is larger than the number of input frames. To make up the additional frames, one common approach is to repeat some of the input frames. For example, in FIG. 2b, the output frames are obtained by repeating each input frame once while, in FIG. 2c, the frame N−1 and the frame N+1 are repeated once. There are various other ways to produce these additional frames such as using black insertion or calculation in accordance with some algorithm. Please note that the method of producing additional frames may vary depending on the multiple of frame rate upgrade. In addition, what are shown in FIGS. 2b and 2c is only exemplary and it is not intended to imply they are the only ways to provide the additional frames. For simplicity, in the following, the principle of the present invention is explained using the most common frame rate upgrade: doubling the frame rate.

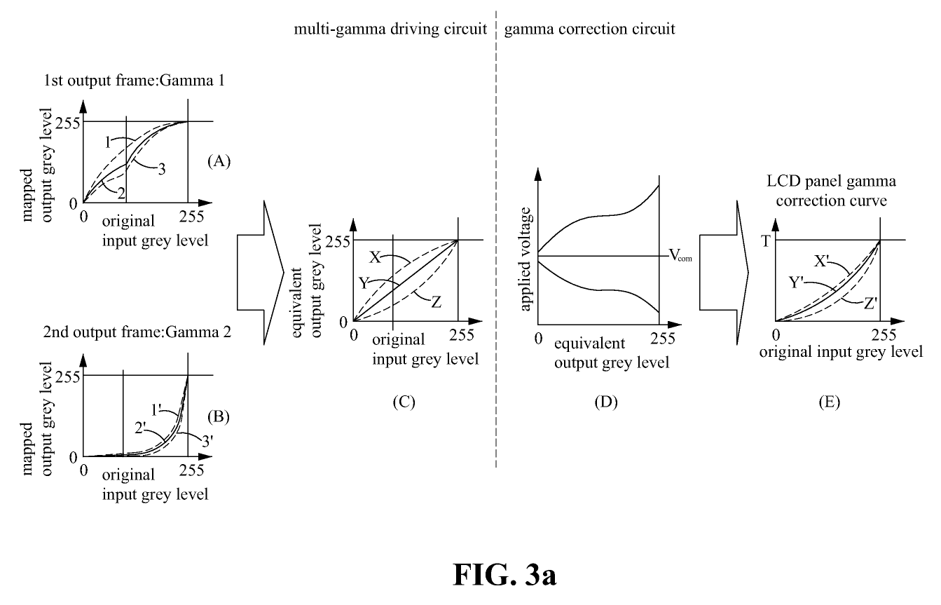

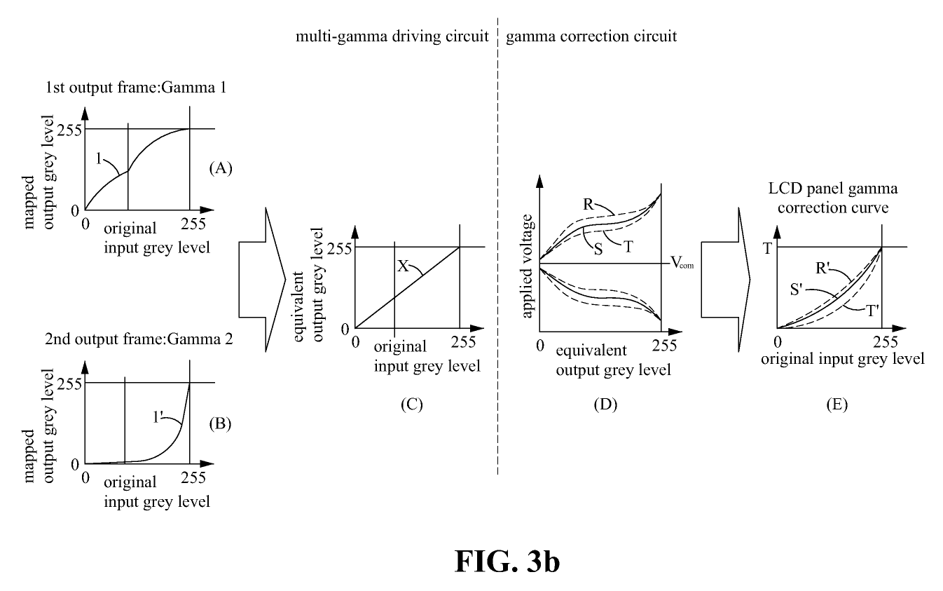

Please refer to FIG. 2a again. A major characteristic of the present invention is that the multi-gamma driving circuit module produces a gamma1 value and a gamma2 value and the corresponding gamma mapping curves based on the two values. The scenario of an embodiment of this multi-gamma driving method is illustrated in FIG. 3a. In the present embodiment, as every two consecutive output frames are identical, the first one is referred to as the first output frame and the second one as the second output frame hereinafter. For the first output frame, the multi-gamma driving circuit 115 maps the grey levels of its pixels to their corresponding and corrected grey levels in accordance with the gamma mapping curve based on the gamma1 value (hereinafter, the gamma1 curve). Then, for the second output frame, the multi-gamma driving circuit 115 maps the grey levels of its pixels to their corresponding and corrected grey levels in accordance with the gamma mapping curve based on the gamma2 value (hereinafter, the gamma2 curve). Please note that the gamma1 and gamma2 curves shown in FIG. 3a are only exemplary and two very different curves are adopted to manifest that, based on how the output frames are produced, appropriate gamma1 and gamma2 curves can be used. For example, the gamma2 curve of the present embodiment is particularly designed for the second output frame which is produced by black insertion. In addition, by loading different look-up table (LUT) in the gamma ROM 116 (see FIG. 2a), the gamma1 and gamma2 curves can be the depicted long dashed lines, solid lines, or short dashed lines.

Assuming that the gamma1 and gamma2 curves are the dashed lines 1 and 1′ of diagram(A) and diagram(B), respectively, the first and second output frames corrected by the gamma1 and gamma2 curves would jointly deliver an visual effect equivalent to the curve X shown in diagram(C), due to the integral effect of human eyes. Similarly, if the gamma1 and gamm2 curves are the dashed lines 2 and 2′ of diagram(A) and diagram(B), respectively, the equivalent visual effect would be like the curve Y of diagram(C) and, if the gamma1 and gamm2 curves are the dashed lines 3 and 3′, respectively, the equivalent visual effect would be like the curve Z. Subsequently, in the present embodiment, the output fames corrected by the multi-gamma driving circuit 115 are further processed by the gamma correction circuit 112. In the present embodiment, the gamma correction circuit 112, like a conventional gamma correction circuit, operate in accordance with a fixed gamma correction curve (please compare the curve of diagram(D) of FIG. 3a and the curve of FIG. 1d). At last, after the foregoing process, the gamma correction curve jointly achieved by the LCD panel are the X′, Y′, or Z′ curve of diagram(E) of FIG. 3a, which is the result presented by the LCD panel after the X, Y, or Z curve of diagram(C) is further processed the gamma correction curve of diagram(D).

Accordingly, the characteristic of the present invention is to apply appropriate grey level mapping curves derived from appropriate gamma1 and gamma2 values alternately to the frame-rate-upgraded output frames. Then, a conventional gamma correction circuit is further used to achieve a desired gamma correction curve for the LCD panel. For applications where the frame rate is not exactly doubled, two scenarios, EX1 and E2, are shown at the bottom of FIG. 2c where the frame rate is upgraded to 1.5 times. In the scenario EX2, the gamma1 and gamm2 curves are also applied alternately to the output frames for grey level mapping while, in the scenario EX1, the gamma1 curve is repeatedly applied in some output frames. In other words, the present invention alternately applies two grey level mapping curves to the series output frame after frame rate upgrade and, for any two adjacent output frames, their applied grey level mapping curves could be identical or different (such as in EX1) or always different (such as in EX2). As can be imagined, there would be a very large of possible combinations.

Another embodiment of the multi-gamma driving method is shown in FIG. 3b. In the present embodiment, the multi-gamma driving circuit applies two grey level mapping curves shown in diagram(A) and diagram(B) of FIG. 3b derived from fixed gamma1 and gamma2 values to the first and second output frames. Again, the gamm1 and gamma2 curves shown are only exemplary. After the grey levels of the first and second output frames are mapped, their joint effect would be the equivalent curve X of diagram(C). Subsequently, in the present embodiment, the output frames are further processed by the gamma correction circuit. Please note that, in the present embodiment, the gamma correction curve (e.g., the curve R, S, or T of diagram(D)) provided by the gamma correction circuit is adjustable by loading different LUTs into the ROM (not shown in the diagram) of the gamma correction circuit. Finally, the overall gamma correction curve achieved by the LCD panel after the foregoing process would be one of the R′, S′, or T′ curve of diagram(E), which is the result delivered by the LCD panel after the curve X of diagram(C) is further processed by the R, S, or T curve of diagram(D), respectively.

From the foregoing description, in the previous embodiment, the grey level mapping provided by its multi-gamma correction circuit is adjustable yet the gamma correction curve of the gamma correction circuit is fixed. On the contrary, in the present embodiment, the grey level mapping provided by its multi-gamma correction circuit is fixed yet the gamma correction curve of the gamma correction circuit is adjustable. In either way, both embodiments are able to achieve an identical overall gamma correction curve for the LCD panel.

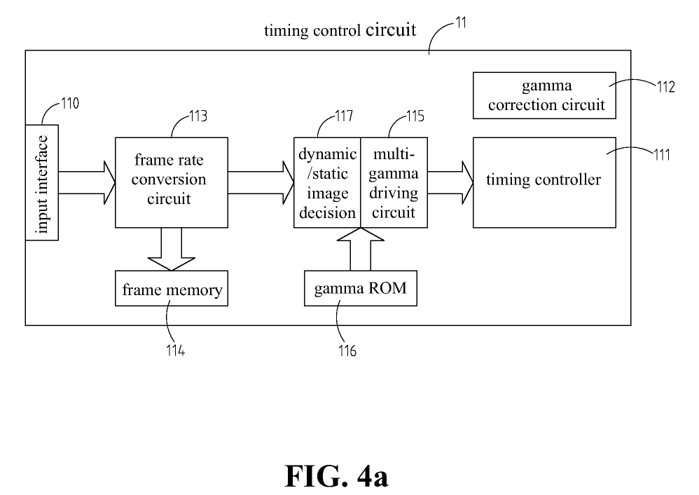

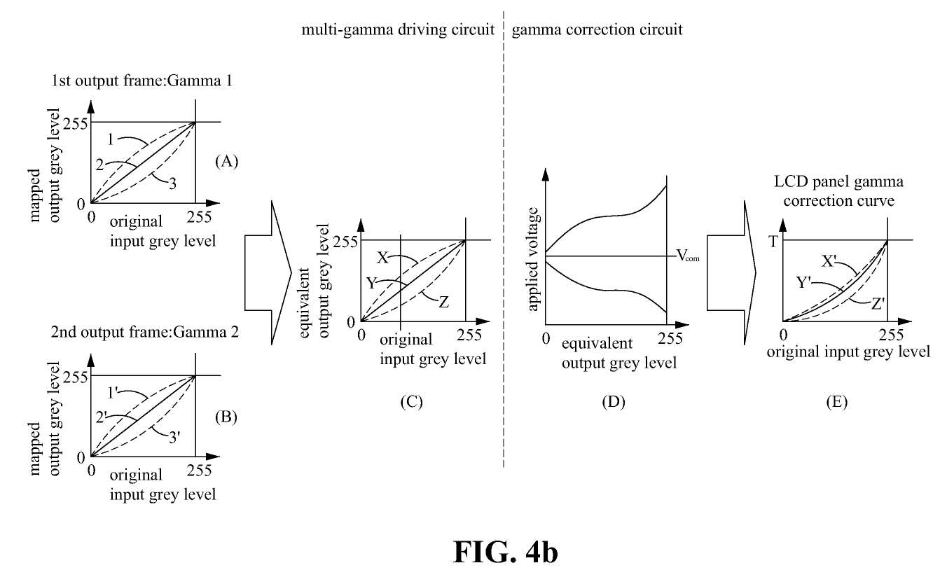

The two embodiments shown in FIGS. 3a and 3b are all able to achieve simultaneously enhancements in brightness and image quality for dynamic images. However, for static images, flickering is possible if the gamma1 and gamma2 curves are very much different. To overcome this problem, another embodiment of the present invention in the timing control circuit of a LCD panel is shown in FIG. 4a. Compared to the timing control circuit 11 of FIG. 2a, the present embodiment has an additional dynamic/static image decision circuit 117 prior to the multi-gamma correction circuit.

In the present embodiment, the dynamic/static image decision circuit 117 first decides whether the output frames contain dynamic or static images. If they are dynamic images, the subsequent processing could be the one shown in FIG. 3a or in FIG. 3b. If they are static images, to avoid flickering, the gamma1 and gamm2 curves provided by the gamma correction circuit is completely or substantially identical, such as the curves 1 and 1′, the curves 2 and 2′, or the curves 3 and 3′, of diagram(A) and diagram(B) of FIG. 4b. In addition, preferably, the curves should be identical to the equivalent curve from the accumulated grey level mapping effect when processing output frames of dynamic images (i.e., the diagram(C) of FIG. 3a). The gamma correction curve of the gamma correction circuit could be fixed (as in FIG. 3a) or adjustable (as in FIG. 3b). In the present embodiment, the former approach is adopted (please compare the diagram(D) of FIG. 3a and FIG. 4b).

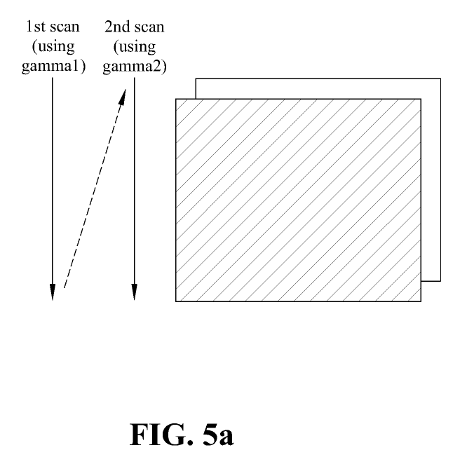

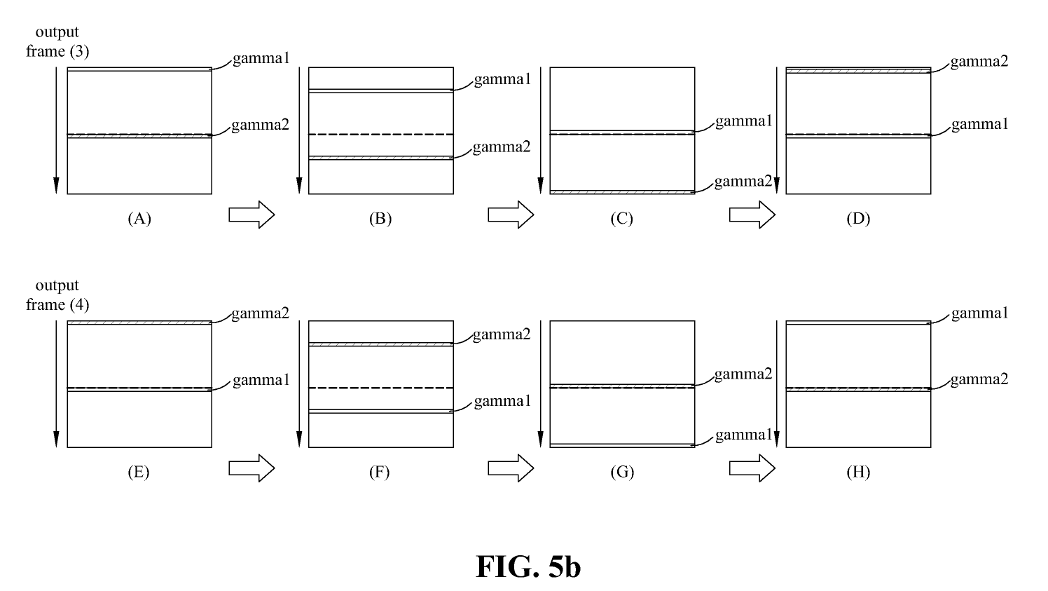

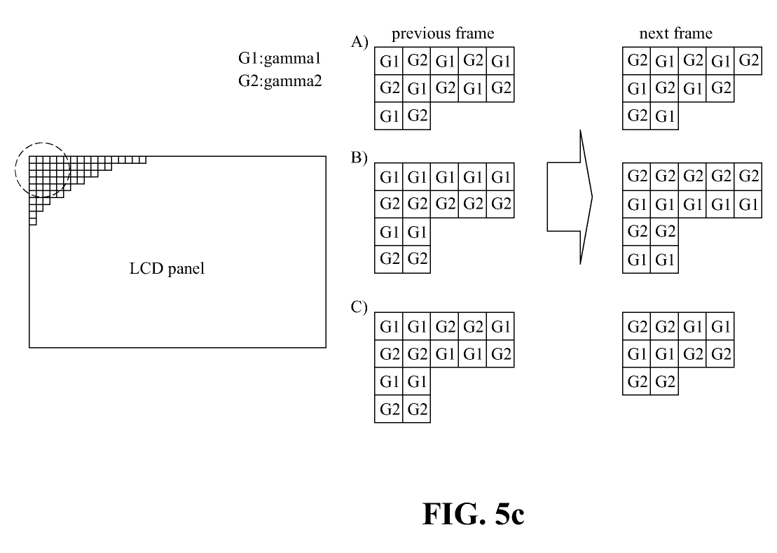

In the foregoing embodiments, the timing controller 111 can scan the first and second output frames in various ways. FIG. 5a is one possible scenario. As illustrated, also with reference to the timing diagram of FIG. 2b, the frame data of the frame N−1 (i.e., frame(1) of FIG. 2b) is processed by the gamma1 curve (and subsequently by the gamma correction curve) and is completely scanned when the frame N−1 is scanned for the first time. When the frame N−1 is scanned for the second time (i.e., frame(2) of FIG. 2b), the frame data of the frame N−1 is processed by the gamma2 curve (and subsequently by the gamma correction curve) and is completely scanned. In the following, the frames N, N+1, etc., are processed and scanned in the same way.

FIG. 5b shows another possible scenario. With reference to the timing diagram of FIG. 2b, when frame (3) is scanned, the rows of pixels are partitioned into non-overlapping first region and second region. When the pixel rows of the upper first region are scanned, the frame data is from the frame N and is processed first by the gamma1 curve (and the gamma correction curve). Then, when the pixel rows of the lower second region are scanned, the frame data is from the frame N−1 and is processed first by the gamma2 curve (and the gamma correction curve). The scenario is depicted by the process from diagram(A) to diagram(D) of FIG. 5b.

When frame (4) is scanned, the rows of pixels are also partitioned into the same non-overlapping first region and second region. When the pixel rows of the upper first region are scanned, the frame data is from the frame N+1 and is processed first by the gamma2 curve (and the gamma correction curve). Then, when the pixel rows of the lower second region are scanned, the frame data is from the frame N and is processed first by the gamma1 curve (and the gamma correction curve). The scenario is depicted by the process from diagram(E) to diagram(H) of FIG. 5b. In other words, the output frames are partitioned into at least two regions. Then, for one output frame, grey level mappings by the gamma1 and gamma2 curves are applied to the frame data of the first and second regions, respectively; and, then for the next output frame, the gamma2 and gamma1 curves are applied to the frame data of the first and second regions, respectively. The alternation is then continued in this way for all subsequent output frames. Therefore, from the view point of a row of pixels, its frame data is processed by, say, the gamma1 curve when it is scanned first; its frame data is then processed by the gamma2 curve when it is scanned for the second time; and its frame data is processed again by the gamma1 curve when it is scanned for the third time, and so on.

The foregoing two approaches perform the alternate application of the gamma1 and gamma2 curves in a temporal manner. In contrast, FIG. 5c provides some approaches whose alternations are performed in a spatial manner. For the approaches A, B, and C, from the view point of a pixel, its grey level is processed by, say, the gamma1 curve when it is scanned at one time, and then by the gamma2 curve when it is scanned at the next time or, in an alternative fashion, its grey level is processed by the gamma2 curve at one time and then by the gamma1 curve at the next time. The difference among the approaches A, B, and C lies only in the order of the application of the grey level mapping curves to the pixels. For example, in approach A, each pixel of a frame is always processed by a grey level mapping curve different from those of its neighboring pixels. And, in approach B, each row of pixels of a frame is always processed by a grey level mapping curve different from those of its neighboring rows. There can be many other spatial alternations, in addition to what is illustrated here. An advantage of the spatial alternation is that it can achieve a greater viewing angle for the LCD panel.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A multi-gamma driving method for a LCD panel, comprising the steps of:
producing a series of output frames from a series of input frames by upgrading the frame rate up to p/q times (p, q are natural numbers and p>q);
conducting grey level mapping to the pixels of the series of output frames; and
conducting gamma correction based on an appropriate gamma correction curve to the series of output frames and scanning the series of output frames to said LCD panel;
wherein said grey level mapping applies a first gamma mapping curve and a second gamma mapping curve in an appropriate alternate manner to the frame-rate-upgraded output frames.

2. The method according to claim 1, wherein at least one of the first and second gamma mapping curves is adjustable.

3. The method according to claim 1, wherein the gamma correction curve is adjustable.

4. The method according to claim 1, wherein the alternate manner is that, for two adjacent frame-rate-upgraded output frames, the grey levels of one frame's pixels are converted by the first gamma mapping curve and the grey levels of the other frame's pixels are converted by the second gamma mapping curve.

5. The method according to claim 1, wherein the alternate manner is that, for the frame-rate-upgraded output frames, one of the first and second gamma mapping curves is applied to convert the grey levels of at least one output frame's pixels before the other gamma mapping curve is applied to convert the grey levels at least a subsequent output frame.

6. The method according to claim 1, wherein the alternate manner is that, for two adjacent frame-rate-upgraded output frames, the grey level of a pixel in the first frame is converted by one of the first and second gamma mapping curves; and the grey level of the pixel in the second frame is converted by the other gamma mapping curve.

7. The method according to claim 1, wherein the alternate manner is that the rows of pixels of each frame-rate-upgraded output frame is horizontally partitioned into a first region and a second region; for two adjacent output frames, the rows of pixels in the first frame's first region and in the second frame's second region are converted by one of the first and second gamma mapping curves; and the rows of pixels in the first frame's second region and in the second frame's first region are converted by the other gamma mapping curve.

8. The method according to claim 4, wherein a frame-rate-upgraded output frame is completely scanned to the LCD panel before the next output frame is scanned.

9. The method according to claim 5, wherein a frame-rate-upgraded output frame is completely scanned to the LCD panel before the next output frame is scanned.

10. The method according to claim 6, wherein a frame-rate-upgraded output frame is completely scanned to the LCD panel before the next output frame is scanned.

11. The method according to claim 7, wherein a frame-rate-upgraded output frame is completely scanned to the LCD panel before the next output frame is scanned.

12. A multi-gamma driving method for a LCD panel, comprising the steps of:
producing a series of output frames from a series of input frames by upgrading the frame rate up to p/q times (p, q are natural numbers and p>q);
determining whether dynamic images are contained in a frame-rated-upgraded output frame;
conducting grey level mapping in accordance to the decision of the previous step to the pixels of the series of output frames; and
conducting gamma correction based on an appropriate gamma correction curve to the series of output frames and scanning the series of output frames to said LCD panel;
wherein said grey level mapping applies a first gamma mapping curve and a second gamma mapping curve in an appropriate alternate manner to the frame-rate-upgraded output frames; and, if a frame-rate-upgraded output frame contains static image, the first and second gamma mapping curves are substantially identical.

13. The method according to claim 12, wherein at least one of the first and second gamma mapping curves is adjustable.

14. The method according to claim 12, wherein the gamma correction curve is adjustable.

15. The method according to claim 12, wherein the alternate manner is that, for two adjacent frame-rate-upgraded output frames, the grey levels of one frame's pixels are converted by the first gamma mapping curve and the grey levels of the other frame's pixels are converted by the second gamma mapping curve.

16. The method according to claim 12, wherein the alternate manner is that, for the frame-rate-upgraded output frames, one of the first and second gamma mapping curves is applied to convert the grey levels of at least one output frame's pixels before the other gamma mapping curve is applied to convert the grey levels at least a subsequent output frame.

17. The method according to claim 12, wherein the alternate manner is that, for two adjacent frame-rate-upgraded output frames, the grey level of a pixel in the first frame is converted by one of the first and second gamma mapping curves; and the grey level of the pixel in the second frame is converted by the other gamma mapping curve.

18. The method according to claim 12, wherein the alternate manner is that the rows of pixels of each frame-rate-upgraded output frame is horizontally partitioned into a first region and a second region; for two adjacent output frames, the rows of pixels in the first frame's first region and in the second frame's second region are converted by one of the first and second gamma mapping curves; and the rows of pixels in the first frame's second region and in the second frame's first region are converted by the other gamma mapping curve.

19. The method according to claim 15, wherein a frame-rate-upgraded output frame is completely scanned to the LCD panel before the next output frame is scanned.

20. The method according to claim 16, wherein a frame-rate-upgraded output frame is completely scanned to the LCD panel before the next output frame is scanned.

21. The method according to claim 17, wherein a frame-rate-upgraded output frame is completely scanned to the LCD panel before the next output frame is scanned.

22. The method according to claim 18, wherein a frame-rate-upgraded output frame is completely scanned to the LCD panel before the next output frame is scanned.

23. A driving system to a LCD panel having a source driving circuit module and gate driving circuit module, comprising
a frame rate conversion circuit producing a series of output frames from a series of input frames by upgrading the frame rate up to p/q times (p, q are natural numbers and p>q);
a multi-gamma driving circuit conducting grey level mapping by applying a first gamma mapping curve and a second gamma mapping curve in an appropriate alternate manner to the pixels of the series of output frames from the frame rate conversion circuit;
a timing controller scanning the series of output frames from the multi-gamma driving circuit to the LCD panel via the source driving circuit module and the gate driving circuit module; and
a gamma correction circuit conducting gamma correction based on an appropriate gamma correction curve to the frame data of the series of output frames before the frame data is applied to the source driving circuit module.

24. The driving system according to claim 23, wherein the first and second gamma mapping curves are stored in a gamma ROM.

25. The driving system according to claim 23, further comprising:
a dynamic/static image decision circuit between the frame rate conversion circuit and the multi-gamma driving circuit for determining whether dynamic images are contained in a frame-rated-upgraded output frame;
wherein, if a frame-rate-upgraded output frame contains static image, the first and second gamma mapping curves applied by the multi-gamma driving circuit are substantially identical.
